(19) United States
(12) Patent Application Publication
(10) Pub. No.: US 2013/0049609 A1
(43) Pub. Date: Feb. 28, 2013

(54) SOLAR POWERED LIGHT HAVING 3D ENHANCED LENS

(71) Applicant: John H. Browder, Argyle, TX (US)

(72) Inventor: John H. Browder, Argyle, TX (US)

(21) Appl. No.: 13/221,457

(22) Filed: Aug. 30, 2011

(51) Int. Cl. H05B 37/02; F21L 4/02; F21L 4/00

(52) U.S. Cl. 315/159; 362/183

(57) ABSTRACT

An aesthetic and practical solar powered light fixture that has a 3D enhanced lens. In one embodiment, the fixture is an independent light capable of being moved to any outdoor position where the fixture will receive sunlight. The solar powered fixture does not require wires to be run or buried since it is solar-powered. The fixture comprises a cap assembly, a lens, a post, and a spike. The medium providing a 3D enhancement for the lens is lenticular lens material. The lens comprises this material and also may have a top and bottom lip for securing the lens to the cap assembly and the post. A light emitting diode in one embodiment may be used to provide the light source for the fixture. Configured in this manner, the fixture provides a welcoming ambiance for a home or business.

### BACKGROUND OF THE INVENTION

1. Technical Field of the Invention

The present invention relates generally to outdoor lighting, particularly to lighting instruments typically positioned around buildings and building pathways used for both aesthetic and practical lighting.

2. Description of the Related Art

Outdoor lighting provides a number of practical and aesthetic benefits for buildings and homes and for garden areas such as lawns, walkways, and pool facilities. Among the practical benefits of this type of lighting are safety for walking and security. These benefits are provided by lighting dark areas and shadows around buildings and homes and lighting walkways, steps, and obstacles.

Outdoor lighting also provides important aesthetic benefits. These benefits include making visible the beauty and charm of a home or business after dark. Features, such as walkways, of a building's exterior may be highlighted and landscape areas may be accented.

Small outdoor lighting fixtures are used to mark walkways and enhance the appearance of landscaping. Some of these small outdoor lighting fixtures include solar panels that capture light energy and then convert the light energy into electrical energy. The electrical energy is then stored in a battery and is directed, when needed, to a light source, such as a light emitting diode (LED), which illuminates upon receiving the electrical energy obtained from the battery.

Current outdoor pathway lights have generally static displays. Previous light fixtures typically have shrouded light sources that are exposed directly to the open air. There are also outdoor landscape lights that have lenses or globes that surround the light sources. These lenses or globes are typically either clear to provide the maximum delivery of light, frosted to provide diffused light, or multi-colored to provide ambiance lighting.

A common variant of such outdoor solar powered light fixtures includes a body having a stake that is driven into a ground surface. At the upper end of the stake, a diffuser lens assembly is mounted that encompasses a chamber which surrounds a light emitting device such as one or more LEDs. The light emitting device extends from the bottom of the cap assembly, which is attached to the open, upper end of the diffuser lens. The cap assembly typically includes a solar panel, a battery assembly, and other electrical components.

To enhance their commercial and decorative value, the structures of such outdoor light fixtures are often made to be as attractive as possible. Previously, a wide variety of efforts have been made that enhance the aesthetic qualities of such outdoor light fixtures. Numerous ornamental designs have been created featuring diffuser lens assemblies and other lens assemblies of various shapes. Nonetheless, a continuing need exists for developing innovative methods and designs to further enhance the aesthetic qualities of such outdoor light fixtures.

### SUMMARY OF THE INVENTION

The present invention provides an aesthetic and practical solar powered light fixture that has a 3D effect.

In one embodiment, the light fixture has a 3D enhanced lens displaying a 3D effect and is situated on top of a cylindrical post having a four-flanged spike attached to the bottom of the post for driving and holding the fixture into the ground. On top of the 3D enhanced lens is a cap assembly which can act as a shroud and supplies the housing for the fixture's light source. Also housed in the cap assembly is a rechargeable battery, a solar panel, and a printed circuit board.

The 3D enhanced lens itself comprises lenticular sheet material and, in some embodiments, may be shaped like a cone. An upper and a lower lip may be added to the lens to facilitate securing the lens to the cap assembly and the post respectively. Additionally, supports are added to the bottom of the lens for stability. The fixture in one embodiment is powered by the solar panel which charges the rechargeable battery while the fixture receives sunlight. The rechargeable battery powers a bright light emitting diode (LED) that shines from behind the 3D lens, enhancing the 3D effect. By changing the angle from which the fixture is viewed, for example when walking by the light fixture, the 3D effect becomes more pronounced.

In an embodiment, the LED in the fixture is turned on and off automatically. The solar panel acts as a photocell that detects when it begins to get dark. The LED then turns on and stays on until the battery is discharged or until the photocell detects daylight again. In certain embodiments, a separate photocell is provided to measure the ambient light conditions and to turn the LED on or off when the ambient light crosses pre-configured thresholds. Likewise, a switch may be provided to turn the LED on or off.

In another embodiment, the light fixture does not have a post or spike. In such an embodiment, the light fixture is able to be hung from different locations. For example, the light fixture may be hung from valences, planter hooks, or placed directly on concrete sidewalks or patios.

In yet another embodiment, a separate solar panel supplies the power to several light fixtures that are connected by wires.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1 is a front perspective view of an embodiment of the light fixture;

FIG. 2A is a front exploded view of an embodiment of the light fixture;

FIG. 2B is a perspective view of a section of the 3D enhanced lens from one angle in one embodiment;

FIG. 2C is a perspective view of a section of the 3D enhanced lens from a second angle in one embodiment showing foreground-background object movement;

FIG. 2D is a perspective view of a section of the 3D enhanced lens from a second angle in one embodiment showing relative position object movement;

FIG. 3 is a close up view of a section of a lenticular lens strip in one embodiment;

FIG. 4A is a close up view of a section of prior art images illustrating how the images are divided into sections;

FIG. 4B is a close up view of a section of a prior art image showing how the sections from FIG. 4A are interleaved to form a lenticular image;

FIG. 5A is a perspective view showing the underside of the cap assembly in one embodiment with the 3D enhanced lens in ghost;

FIG. 5B is a top view perspective of a 3D enhanced lens in one embodiment;

FIG. 6 is a typical electrical schematic in one embodiment;

FIG. 7 is a perspective view of a second embodiment of the light fixture; and

FIG. 8 is a perspective view of another embodiment of the light fixture system.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

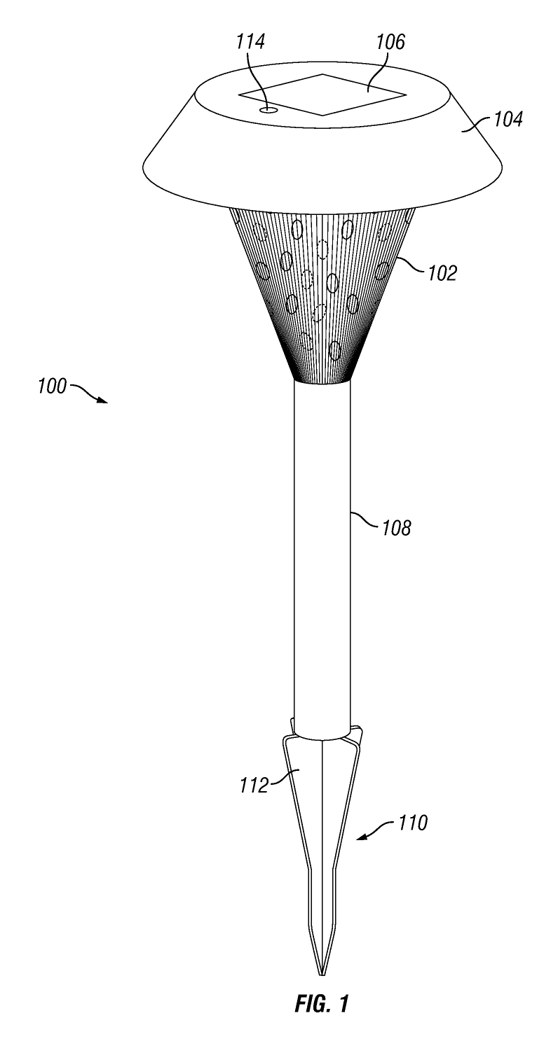

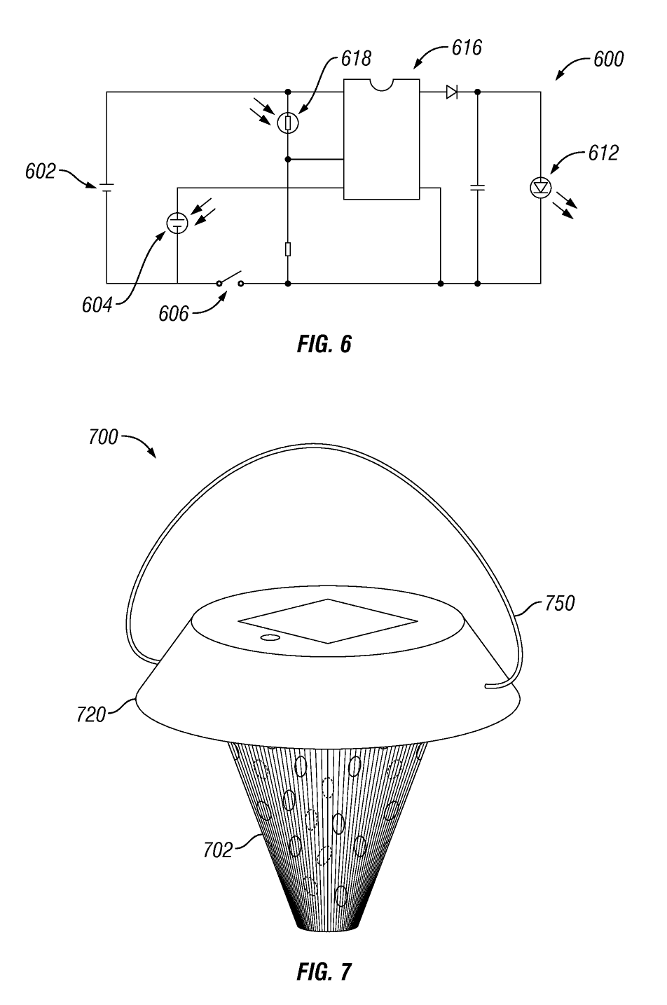

FIG. 1 is a front perspective view of an embodiment of the light fixture. In this embodiment, the light fixture includes a 3D enhanced lens 102. The upper portion of an outdoor lighting fixture 100 comprises the 3D enhanced lens 102 and a cap assembly 104. The cap assembly 104 comprises a solar panel 106 and a photocell 114. The solar cell is used to gather light to charge a rechargeable battery 602 (FIG. 6). The photocell 114 is used to measure the ambient light and can control the function of the fixture when so configured. In an embodiment, the solar panel 106 acts as the photocell.

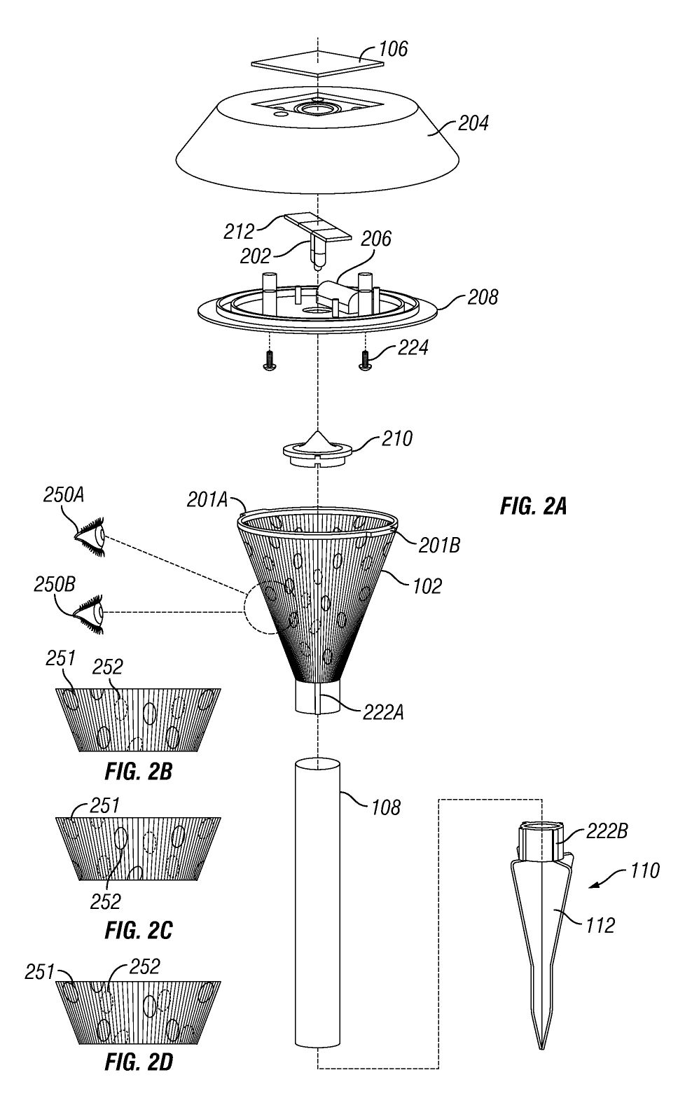

An exploded view of the fixture 100 is provided in FIG. 2A. In this view, components of the cap assembly 104 can be seen. In this embodiment, the cap assembly 104 comprises the solar panel 106, an upper housing 204, a printed circuit board (PCB) 212, a light source 202, and a bottom plate 208. The bottom plate comprises a battery housing 206 that houses the rechargeable battery (not shown). In another embodiment, the bottom plate 208 may also contain a switch 606 (FIG. 6) to control the functioning of the light. In one embodiment, the switch controls the light turning on or off. For example, when the switch is in one position the light is on, and when the switch is in another position, the light is turned off. It is envisioned that the switch may control other functions. Multiple switches or multi-position switches to control a combination of functions are also envisioned. In this embodiment, the fixture has a reflector 210 used to reflect light from the light source 202 onto the 3D enhanced lens 102. The reflector 210 can be made from any material capable of reflecting light. For example, the reflector can be made of metal, plastic, or glass. The reflector may also be made of any material capable of being coated with a reflective material such as chrome.

In one embodiment, the outdoor lighting fixture 100 has a four-flanged spike 110 which holds the fixture firmly in place. The spike may be used to hold the outdoor lighting fixture in a number of landscape materials such as dirt or gravel. Although, the current embodiment has a four-flanged spike 110, as one skilled in the art would easily recognize, spike 110 may have any number of flanges 112, or no flanges at all.

As depicted, the spike 110 is connected to a cylindrical post 108. The flanges 112 extend beyond the circumference of the post 108 at the top of the spike 110 and have a stair-step taper until the flanges meet at a point at the bottom of the spike 110. The post 108 supports the upper portion of the outdoor lighting fixture 100 and, in this embodiment, sets the elevation of the light.

FIG. 2A is a front exploded view of an embodiment of the light fixture. As can be seen, small, tapered, tabular protrusions 222 are used to connect the spike 110 and the lens 102 to the post 108 by friction. Other methods of securing the spike 110 and the lens 102 to the post 108, such as screw posts or glue, are also practical and well known to one skilled in the art of manufacturing or designing lighting fixtures. In the embodiment shown in FIG. 2A, the bottom plate 208 is connected to the upper housing 204 by one or more screws 224. Any number of fastening methods may be used to secure the solar panel 106, upper housing 204, printed circuit board 212, and bottom plate 208 including screws, glue, clamps, and pressure tabs.

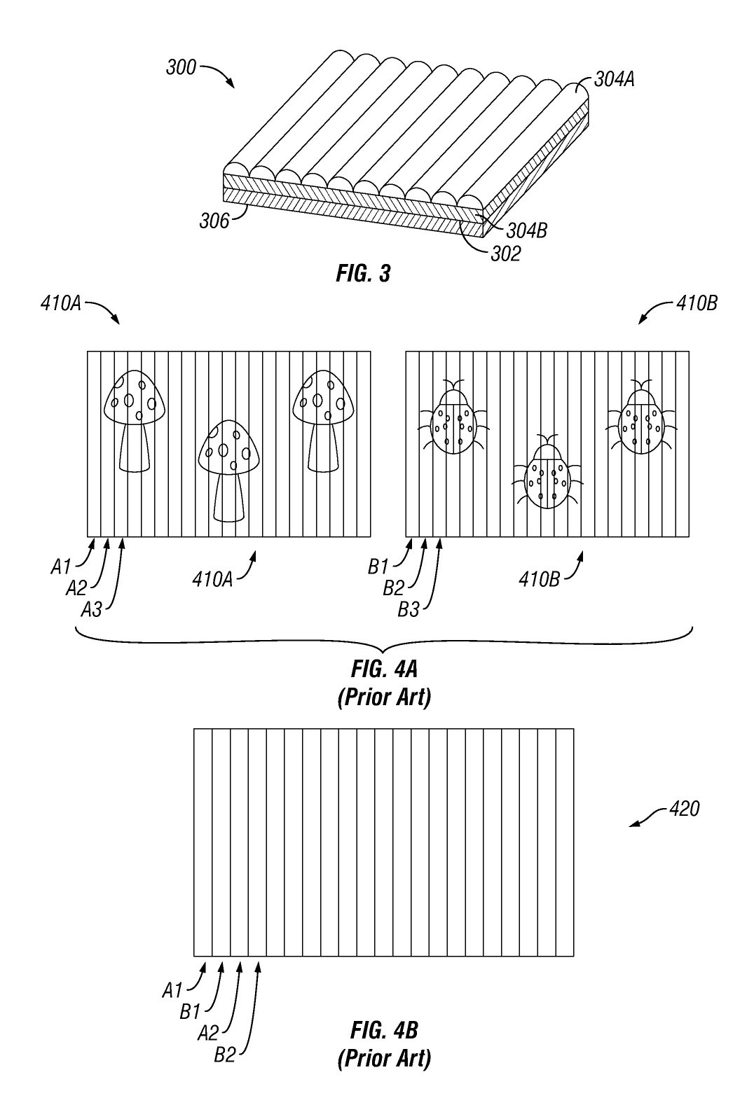

In one embodiment, the 3D enhanced lens 102 is a substantially conically shaped lens covered by lenticular strip material 300 (FIG. 3). The light source 202 is connected to the printed circuit board 212 and may be, for example, an incandescent light, light emitting diode, or an array of light emitting diodes. In one embodiment, a surface mount LED is used as the light source. The light source 202 is located behind the 3D enhanced lens 102. By placing the light source 202 behind the 3D lens, the 3D experience is improved. An observer 250 will experience an enhanced 3D effect when the observer's position is changed relative to the fixture.

FIGS. 2B and 2C are perspective views of a section of the 3D enhanced lens from different angles. FIGS. 2B and 2C illustrate how the 3D effect changes from different observer views 250A and 250B by changing the observer's position relative to the fixture. FIG. 2B shows, in one embodiment, certain objects 251 in the imbedded image appearing in the foreground while other objects 252 appear in the background from one viewing angle 250A. FIG. 2C illustrates when the observer views the same portion of the lens from a different angle 250B. When moving from viewing angle 250A to the angle 250B, the objects 252 appear to move from the background to the foreground, while other objects 251 will appear to move from foreground to background.

In addition or instead of moving from foreground to background and from background to foreground, the objects 251 and 252 may show a 3D effect by appearing to move relative to each other. For example, an object 251 may appear to pass in front of an object 252 when an observer views the 3D enhanced lens 102 from different angles. FIGS. 2B and 2D illustrate how, in one embodiment, objects 251 and 252 appear to move relative to each other with respect to the objects 251 and 252.

FIG. 3 is a close up view of a section of a lenticular lens strip in one embodiment. A magnified portion of a lenticular lens sheet 300 is illustrated. The lens sheet 300 is made up of a number of lenticular lenses each having a cylindrical portion 304A and a thickness portion 304B. A 3D image 302 is placed on the bottom surface of the thickness portion of the lens 304B. As used herein, the term 3D image means any image creating the impression of depth. The 3D image may be attached to the bottom surface in several ways. For example, the image may be printed directly on the bottom surface or placed on a laminate sheet 306 and then sealed to the bottom of the thickness portion 304B. The 3D image 302 may also be laminated to the lenticular sheet 300 by using a double-sided adhesive sheet.

The lenticular lens material 300 may be made of any number of translucent or semi-translucent materials such as plastic or glass. As used herein, translucent or semi-translucent means allowing the passage of visible light. In one embodiment, the lenticular lens material spans the length of the lens. In other embodiments the lens is only partially made up of lenticular lens material. The lens may be made of more than one layer of translucent or semi-translucent material, however, at least one layer comprises lenticular lens material.

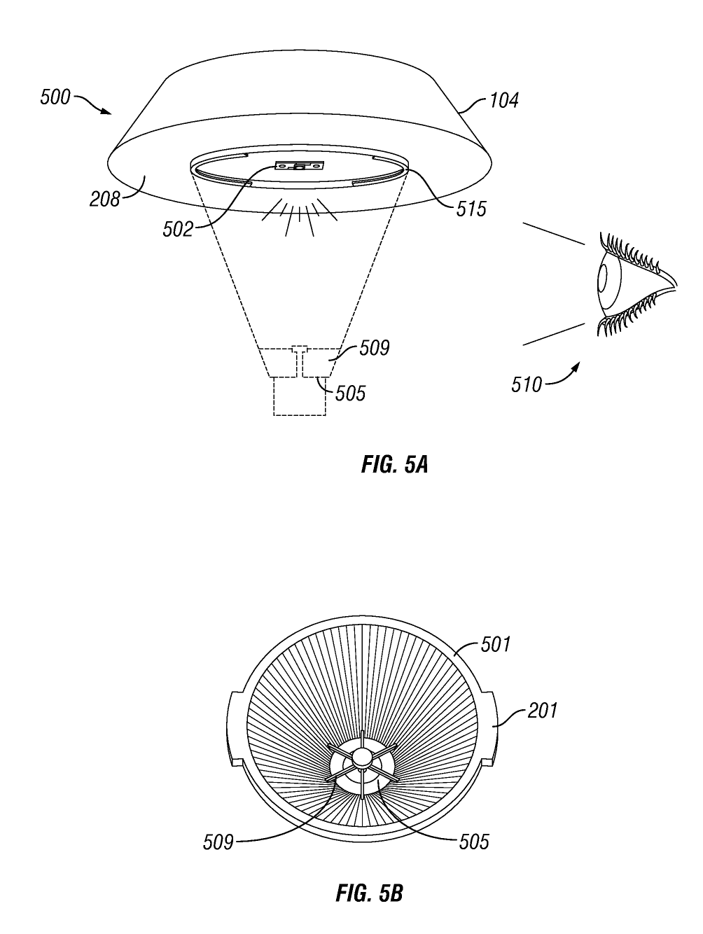

FIGS. 4A and 4B are close up views of a section of a prior art image showing how the sections from FIG. 4A are interleaved to form a lenticular image. The 3D image 302 is formed by interlacing two or more images 410 as can be seen in FIGS. 4A and 4B. A first image 410A is divided up into a number of sections (e.g. A1-A3) with a width corresponding to a portion of the diameter of the cylindrical portion of the lens 304A. Other images 410B may be divided up in a similar manner. The separate images 410 may be of different subjects to create a “flip” image, or of different angles of the same subject to create a 3D effect. FIG. 4B illustrates an example of the image interleaving process.

FIG. 5A is a perspective view showing the underside of the cap assembly in one embodiment with the 3D enhanced lens in ghost. The 3D enhanced lens 102 of the embodiment in FIG. 5A provides an improved aesthetic and viewing experience for the observer 510. One advantage of the 3D enhanced lens is that the improved aesthetic is also available during the daytime when the light source may not be shining. As the observer 510 passes by the light fixture, the objects in the 3D image appear to move with the observer. This provides an inviting effect and makes an observer feel more relaxed and welcome when viewing the light fixture. When viewed at night, when the light source is illuminated, the 3D experience is further enhanced by light passing through the 3D enhanced lens.

FIG. 5B is a top view perspective of a 3D enhanced lens 102 in one embodiment. In this embodiment, the top of the lens 102 has a lip 501 with two mounting tabs 201. The tabs 201 align with slots 515 in the bottom plate 208 of the cap assembly 104. This is a friction fitting similar to a bayonet fitting requiring a slight clockwise or counterclockwise twist of the lens 102 with respect to the cap assembly 104 to secure or to loosen the 3D lens from the bottom plate 208.

The bottom of the 3D lens also has a lip 505 which supports six support flanges 509 which in turn are connected at the center of the bottom of the 3D lens 102. The flanges provide structural support for the 3D lens 102. Although, the current embodiment has six support flanges 509, as one skilled in the art would easily recognize, lens 102 may have any number of flanges 509, or no flanges at all.

FIG. 6 is a typical electrical schematic 600 in one embodiment. The exemplary circuit 600 comprises electrical components configured on a printed circuit board 212 (FIG. 2). The circuit 600 comprises a photocell light sensor 618, an LED light source 612 and a rechargeable battery 602 coupled to a solar panel 604. The rechargeable battery 602, in one embodiment, is used to provide electrical current to the LED light source 612 comprising one or more light emitting diodes.

A photocell light sensor 618 and other circuit elements are included in an embodiment to turn the LED light source 612 on and off when the light sensor 618 detects a certain level of ambient light. The light sensor 618 is typically isolated from the LED light source 612 so that the light sensor 618 does not receive light from the LED light source. When the light sensor 618 detects a certain level of light above a predetermined threshold (for example, the light sensor 618 is exposed to sunlight), the integrated circuit 616 prevents the flow of electricity from the battery 602 to the LED light source 612. Conversely, when the light sensor 618 detects a light level below a predetermined threshold (e.g., the sensor is exposed to darkness), the integrated circuit 616 permits the flow of electricity from the battery 602 to the LED light source 612. In another embodiment, the solar panel 604 acts as a photocell. In this embodiment, the integrated circuit 616 automatically detects when the solar panel 604 is receiving light for charging and automatically turns the LED light source 612 off until the solar panel is no longer detecting light.

A switch 606, in one embodiment, is also provided to control the system (for example, to turn the system on and off). Opening the switch 606 prevents electricity from flowing from the battery 602 and the solar panel 604 to the integrated circuit 616 and the LED light source 612.

The embodiment 700 in FIG. 7 is a perspective view of another embodiment of the light fixture that illustrates one of the ways that the light fixture may be employed without using a stake placing the fixture near the ground. This embodiment 700 is also a solar powered outdoor lighting fixture as previously described that can be located and continuously operated in any area that receives daytime exposure to sunlight. The light fixture 700 is designed to be a hanging variant. Thus, the light fixture 700 depicted does not include a spike for attachment to the ground. Instead, the light fixture 700 comprises a 3D lens assembly 702 removably attached to a cap assembly 720 that includes a hanging instrument 750.

As previously described in another embodiment, the cap assembly 720 houses the power and control assemblies of the present system. In addition, the cap assembly 720 may also include a hanging mechanism 750. For example, as shown in FIG. 7, the hanging mechanism 750 comprises a length of wire or cord having its two distal ends attached to a peripheral edge of the cap assembly 720. Configured in this manner, the fixture may be hung using the hanging device 750 from items such as planter hooks, valences, or fence posts. Additionally, the light fixture may be placed directly on concrete or other surfaces not suitable for driving a stake into. The portability of this embodiment also has the advantage of being able to easily move the fixture to a sunny or well-lit location for charging the battery, and then moving the fixture to another location that may not have sufficient daytime lighting or sunshine.

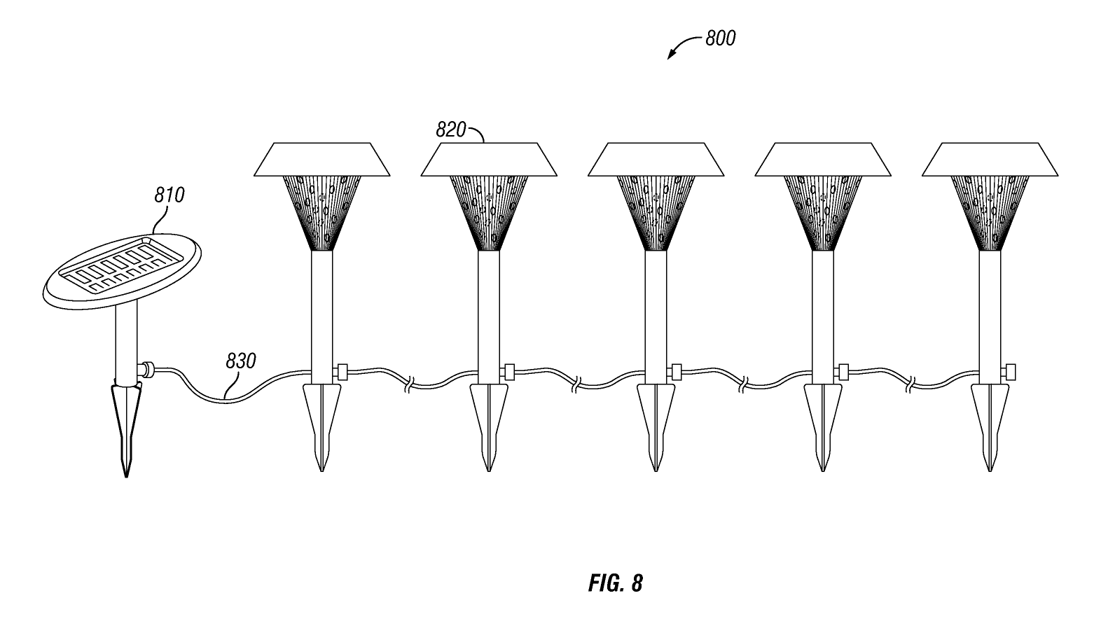

FIG. 8 is a perspective view of another embodiment of the light fixture system that shows the system 800 comprising a solar panel 810 used to provide electrical power to a number of light fixtures 820 by wires 830. In this embodiment, the rechargeable batteries may be co-located with the solar panel 810 or located in each individual lighting fixture 820. An advantage of the system 800, is that the solar panel 810 may be placed in a location that is likely to receive direct sunlight while the individual light fixtures 820 may be placed in locations less likely to receive direct sunlight such as under a shrubbery, a tree, or other shade producing object. Additionally, the solar panel 810 may be much larger with respect to the size of the cap assembly 204 providing a larger surface to support solar panels much larger than the solar panel 106.

While the present invention has been disclosed according to its preferred and alternate embodiments, those of ordinary skill in the art will understand the other embodiments have been enabled by the foregoing description. Such other embodiments shall be included in the scope and meaning of the appended claims.

More than one embodiment has been described. In one embodiment, a solar powered light having a 3D lens comprises a cap assembly having a solar panel operatively coupled to a rechargeable battery and a light source operatively coupled to the rechargeable battery, wherein the rechargeable battery receives its charging power from the solar panel and the light source receives its operational power from the rechargeable battery; and a lens having a bottom portion and a top portion, the lens surrounding the light source wherein the lens comprises lenticular sheet material and wherein the lens is configured to be coupled to the cap assembly.

In another embodiment, a solar powered light having a 3D lens comprises a lens having a bottom portion and a top portion, the lens surrounding a light source, wherein the lens presents a 3D image, the lens is at least semi-translucent, and the lens is configured to be coupled to a cap assembly comprising a solar panel operatively coupled to the light source.

It will now be evident to those skilled in the art that there has been described herein an improved solar powered light fixture. Although the invention hereof has been described by way of an embodiment, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

I claim:

1. A solar powered light fixture comprising:
a cap assembly having a solar panel operatively coupled to a battery and a light source operatively coupled to the battery;
a lens having a bottom portion and a top portion, the lens surrounding the light source wherein the lens comprises lenticular sheet material and wherein the lens is configured to be coupled to the cap assembly.

2. The light fixture of claim 1, wherein the light source comprises at least one light emitting diode.

3. The light fixture of claim 1, wherein the lens is substantially conically shaped.

4. The light fixture of claim 1, wherein the cap assembly further comprises a photocell configured to measure ambient light.

5. The light fixture of claim 1, wherein the solar panel provides power to a plurality of light fixtures.

6. The light fixture of claim 1, further comprising a hanging instrument coupled to the cap assembly.

7. The light fixture of claim 1, further comprising:
a post having a top end and a bottom end; and
a spike, wherein the bottom end of the post is coupled to the spike and the top end is coupled to the bottom portion of the lens.

8. The light fixture of claim 1, wherein the lenticular material having an inside surface is used to present a 3D image coupled to the inside surface.

9. The light fixture of claim 1, wherein the light source is automatically turned off while the solar panel charges the rechargeable battery.

10. A solar powered light fixture comprising:
a lens having a bottom portion and a top portion, the lens surrounding a light source, wherein the lens presents a 3D image, the lens is at least semi-translucent, and the lens is configured to be coupled to a cap assembly comprising a solar panel operatively coupled to the light source.

11. The light fixture of claim 10, wherein the cap assembly is coupled to the lens by a tab and slot fitting.

12. The light fixture of claim 10, wherein the light source comprises at least one light emitting diode.

13. The light fixture of claim 10, wherein the lens comprises lenticular lens material.

14. The light fixture of claim 10, wherein the lens is substantially conically shaped.

15. The light fixture of claim 14, wherein the substantially conically shaped lens comprises lenticular lens material.

16. The light fixture of claim 10, wherein the cap assembly further comprises a photocell configured to measure ambient light.

17. The light fixture of claim 10, wherein the solar panel provides power to a plurality of light fixtures.

18. The light fixture of claim 10, further comprising a hanging instrument coupled to the cap assembly.

19. The light fixture of claim 10, further comprising a switch electrically coupled to the solar panel for turning the light source on and off.

20. The light fixture of claim 10, wherein the light source is automatically turned off while the solar panel charges the rechargeable battery.
